(19) United States
(12) Patent Application Publication
(10) Pub. No.: US 2026/0301695 A1
(43) Pub. Date: Oct. 1, 2026

(54) DISPLAY DEVICE

(71) Applicant: LG Display Co., Ltd., Seoul (KR)

(72) Inventor: Mookyoung HONG, Paju-si (KR)

(73) Assignee: LG Display Co., Ltd., Seoul (KR)

(21) Appl. No.: 19/544,293

(22) Filed: Feb. 19, 2026

(30) Foreign Application Priority Data
Mar. 28, 2025 (KR) 10-2025-0040509

(51) Int. Cl. G09G 3/3275; G09G 3/32

(52) U.S. Cl. CPC G09G 3/3275; G09G 3/32; G09G 2300/0819; G09G 2310/0275; G09G 2310/08; G09G 2330/021

(57) ABSTRACT

A display device can include a display panel having a pixel comprising a light emitting element configured to emit light and connected to a data line and a sensing line, and a display driver configured to receive a sensing signal from the sensing line at a first RT interval, a second RT interval, and an OFF-RS interval. The display driver can include a first switching element configured to be turned on based on a first switching signal at the first RT interval and electrically connect a reference voltage line to the sensing line, a second switching element configured to be turned on based on second switching signal at the OFF-RS interval and electrically connect a low potential line to the sensing line, and a third switching element configured to be turned on based on a third switching signal at the second RT interval.

### CROSS-REFERENCE TO RELATED APPLICATION

The present application claims priority to Korea Patent Application No. 10-2025-0040509, filed in the Republic of Korea on Mar 28, 2025, the entire contents of which is incorporated by reference for all purposes.

### BACKGROUND

### Field

The present disclosure relates to a display device.

### Discussion of the Related Art

With the progress of the information-oriented society, various types of demands for display devices which display an image are increasing. Further, various types of display devices such as a liquid crystal display device and an organic light emitting display device have been used.

The images displayed in the display device can be still images or moving images. If the images are moving images, the images can be various kinds such as sports images, game images, movies, and the like. The display device can include a plurality of pixels and a plurality of switching elements for driving the pixels.

### SUMMARY OF THE DISCLOSURE

One or more technical problems are addressed by the features of the present disclosure which provide a display device capable of performing sensing easily at a real time sensing (RT) interval which is relatively small and has a high frequency and a high resolution, and determining an appropriate compensation value by securing a constant sensing value.

The technical problem to be addressed by the present disclosure are not limited to the above-mentioned technical problems, and other technical problems that are not mentioned will be inferred.

One embodiment of the present disclosure provides a display device, including: a display panel having a pixel comprising a light emitting element configured to emit light and connected to a data line and a sensing line; and a display driver configured to receive a sensing signal from the sensing line at a first real time sensing (RT) interval, a second RT interval, and an off-state real time sensing (OFF-RS) interval, and the display driver can include: a first switching element configured to be turned on based on a first switching signal at the first RT interval and electrically connect a reference voltage line to the sensing line; a second switching element configured to be turned on based on second switching signal at the OFF-RS interval and electrically connect a low potential line to the sensing line; and a third switching element configured to be turned on based on a third switching signal at the second RT interval and electrically connect a variable initialization line to the sensing line.

Another embodiment of the present disclosure provides a display device, including: a display panel having a pixel comprising a light emitting element configured to emit light and connected to a data line and a sensing line; and a display driver configured to receive a sensing signal from the sensing line at a first RT interval, a second RT interval, and an OFF-RS interval, and the display driver can include: a mux (or multiplexer) configured to receive a reference voltage from a reference voltage line, receive a low potential voltage from a low potential line, and receive a variable initialization voltage from a variable initialization line; and a switching element configured to be turned on based on one among first to third switching signals and supply one among the reference voltage, the low potential voltage, and the variable initialization voltage to the sensing line.

Other details of the embodiments of the present disclosure are included in the detailed description and the accompanying drawings.

The display device according to the embodiments of the present disclosure can perform sensing easily at the RT interval which is relatively small and has a high frequency and a high resolution by using a variable initialization voltage having each different voltage level at each of the RT interval and the OFF-RS interval, and can determine an appropriate compensation value by securing a constant sensing value.

The display device according to the embodiments of the present disclosure can perform sensing at the RT interval even in a case where a data voltage is reduced by decreasing a power supply voltage so as to reduce power consumption.

However, effects which can be obtained by the present disclosure are not limited to the aforementioned effects, and other technical effects not described above can be evidently understood by a person having ordinary skill in the art to which the present disclosure pertains from the following description.

### BRIEF DESCRIPTION OF THE DRAWINGS

The present disclosure will become more fully understood from the detailed description given hereinbelow and the accompanying drawings which are given by way of illustration only, and thus are not limitative of the present disclosure.

FIG. 1 is a plan view illustrating a display device according to an embodiment of the present disclosure.

FIG. 2 is a block diagram illustrating a display device according to an embodiment of the present disclosure.

FIG. 3 is a circuit diagram illustrating a display driver and a pixel of a display device according to an embodiment of the present disclosure.

FIG. 4 is a timing diagram illustrating a signal and a voltage at a first RT interval in a display device according to an embodiment of the present disclosure.

FIG. 5 is a circuit diagram illustrating an operation of a display driver and a pixel according to a timing diagram in FIG. 4.

FIG. 6 is a timing diagram illustrating a signal and a voltage at a second RT interval in a display device according to an embodiment of the present disclosure.

FIG. 7 is a circuit diagram illustrating an operation of a display driver and a pixel according to a timing diagram in FIG. 6.

FIG. 8 is a timing diagram illustrating a signal and a voltage at an OFF-RS interval in a display device according to an embodiment of the present disclosure.

FIG. 9 is a circuit diagram illustrating an operation of a display driver and a pixel according to a timing diagram in FIG. 8.

FIG. 10 is a circuit diagram illustrating a connection relationship among a display driver, a power supply unit, and a timing controller in a display device according to an embodiment of the present disclosure.

FIG. 11 is a circuit diagram illustrating a connection relationship among a display driver, a power supply unit, and a timing controller in a display device according to another embodiment of the present disclosure.

FIG. 12 is a block diagram illustrating a driving module and a sensing module of a display driver in a display device according to an embodiment of the present disclosure.

### DETAILED DESCRIPTION OF THE EMBODIMENTS

Hereinafter, embodiments of the disclosure will be described with reference to the drawings. In this specification, when it is mentioned that a component (or, an area, a layer, a part, etc.) is referred to as being “on”, “connected to” or “combined to” another component, this means that the component can be directly on, connected to, or combined to the other component or a third component therebetween can be present.

Like reference numerals refer to like elements. Additionally, in the drawings, the thicknesses, proportions, and dimensions of components are exaggerated for effective description. Further, the term “and/or” includes all of one or more combinations defined by related components.

It will be understood that when the terms such as “first” and “second” are used herein to describe various components, these components should not be limited by these terms. The above terms are used only to distinguish one component from another and may not define order or sequence. For example, a first component can be referred to as a second component and vice versa without departing from the scope of the present disclosure. Singular expressions and terms used herein also encompass or include plural expressions and terms, unless the context clearly indicates otherwise.

In addition, terms such as “below”, “the lower side”, “on”, and “the upper side” are used to describe a relationship of configurations shown in the drawing. The terms are described as a relative concept based on a direction shown in the drawing.

In various embodiments of the disclosure, the term such as “include,” “comprise,” “including,” or “comprising,” specifies a property, a fixed number, a step, a process, an element and/or a component, or a combination thereof, but does not exclude presence or addition of other properties, fixed numbers, steps, processes, elements and/or components, or a combination thereof. Further, the term “can” fully encompasses all the meanings and coverages of the term “may” and vice versa.

Now, various embodiments of the present disclosure will be discussed referring to the drawings. All the components of each display device/apparatus according to all embodiments of the present disclosure are operatively coupled and configured.

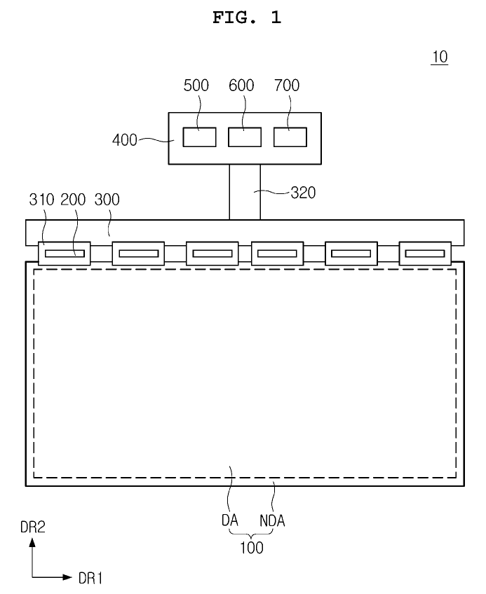

FIG. 1 is a plan view illustrating a display device according to an embodiment of the present disclosure.

Referring to FIG. 1, a display device 10 can be applied to a portable electronic device such as a mobile phone, a smart phone, a tablet personal computer, a mobile communication terminal, an electronic organizer, an e-book reader, a portable multimedia player (PMP), a navigation apparatus, an ultra-mobile PC (UMPC), and the like. For example, the display device 10 according to the present embodiment can be applied as a display unit of a television, a notebook computer, a monitor, a billboard, an Internet of things (IoT) device, and the like. As another example, the display device 10 can be applied to various wearable devices such as smart watches, watch phones, glass-like displays, head-mounted displays (HMDs), and the like.

The display device 10 can include a display panel 100, a display driver 200, a source circuit board 300, a flexible film 310, a flexible cable 320, a control circuit board 400, a timing controller 500, a power supply unit 600, and a memory 700.

The display device 10 can include a display region DA and a non-display region NDA. The display region DA can include a plurality of pixels SP configured to display an image. Each of the plurality of pixels can emit light from a light emitting region or an opening region. For example, the display region DA can include a pixel circuit including switching elements, a pixel defining layer defining the light emitting region, and a self-light emitting element.

For example, the self-light emitting element can include at least one among an organic light emitting diode including an organic light emitting layer, a quantum-dot light emitting diode (LED) including a quantum-dot light emitting layer, an inorganic light emitting diode (LED) including an inorganic semiconductor, and a micro-light emitting diode (LED) or a nano-light emitting diode (LED), but is not limited thereto.

The display driver 200 can supply a data voltage to a data line of the display panel 100. The display driver 200 can be electrically connected to the flexible film 310, and to a data line DL of the display panel 100 through a pad part of the display panel 100. The display driver 200 can be formed as an integrated circuit (IC). For example, the display driver 200 can be attached to one surface of the flexible film 310 in a chip-on-film (COF) manner. The flexible film 310 can include lines electrically connecting the display driver 200 and the display panel 100. One side of the flexible film 310 can be electrically connected to the pad part of the display panel 100, and the other side of the flexible film 310 can be electrically connected to the source circuit board 300.

The source circuit board 300 can electrically connect the control circuit board 400 and the flexible film 310 to each other. The source circuit board 300 can be a printed circuit board which includes lines electrically connecting the display driver 200 and other devices to one another. The source circuit board 300 can be electrically connected to the control circuit board 400 through the flexible cable 320. For example, the flexible cable 320 can be a flexible flat cable (FFC), but is not limited thereto.

The control circuit board 400 can be a printed circuit board in which the timing controller 500, the power supply unit 600, and the memory 700 are mounted. The control circuit board 400 can mount control components and various electronic devices therein, without limitation to the drawing of FIG. 1.

The timing controller 500 can be attached to one surface of the control circuit board 400. The timing controller 500 can control the operation timing of the display driver 200 by transmitting digital video data to the display driver 200.

The power supply unit 600 can generate the power supply voltage and supply the power supply voltage to the display panel 100. Here, the power supply voltage can include a driving voltage EVDD, a low potential voltage VSS, an initialization voltage Vint, a reference voltage VREF, and a bias voltage Vbias, but is not limited thereto.

The memory 700 can store sensing information of the pixels. For example, the memory 700 can store information on a threshold voltage of the transistor received from the display driver 200, and supply the threshold voltage information to the timing controller 500.

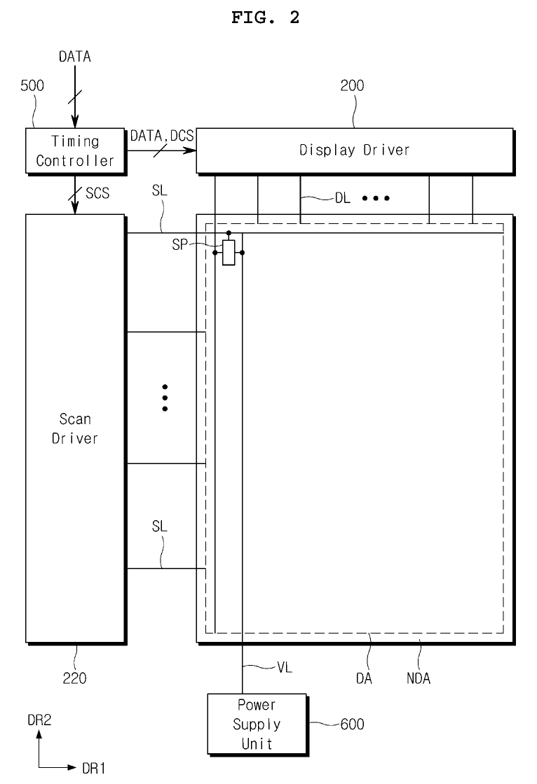

FIG. 2 is a block diagram illustrating a display device according to an embodiment of the present disclosure.

Referring to FIG. 2, the display panel 100 can include a display region DA and a non-display region NDA. The display region DA can include a plurality of pixels SP, a power supply line VL, a scan line SL, and the data line DL connected to the pixel SP.

Each of the pixels SP can be connected to the scan line SL, the data line DL, and the power supply line VL. Each of the pixels SP can include a transistor, a light emitting element, and a capacitor.

The scan lines SL can extend in a first direction DR1, and can be spaced from each other in a second direction DR2 intersecting the first direction DR1. The scan lines SL can sequentially supply the scan signals to the plurality of pixels SP.

The data lines DL can extend in the second direction DR2, and can be spaced from each other in the first direction DR1. The data lines DL can supply the data voltage to the pixels SP. The data voltage can determine luminance of the pixel SP.

The power supply lines VL can extend in the second direction DR2, and can be spaced apart from each other in the first direction. The power supply lines VL can supply a power supply voltage to the plurality of pixels SP. The power supply voltage can include the driving voltage VDD, the low potential voltage VSS, the initialization voltage Vint, the reference voltage VREF, and the bias voltage Vbias, but is not limited thereto.

The scan driver 220 can include a plurality of transistors, and can generate scan signals based on a scan control signal SCS. The scan driver 220 can shift a scan signal using a shift register, and can sequentially supply the shifted scan signals to the scan lines SL. The scan signals of the scan driver 220 can select the pixels SP to which the data voltage is supplied, and the selected pixels SP can receive the data voltage through the data lines DL. The scan driver 220 can be disposed on one side or both sides of the non-display region DNA in a Gate-In-Panel (GIP) manner.

The timing controller 500 can receive digital video data DATA and timing signals from a host system or a set module. The timing controller 500 can generate the data control signal DCS based on the timing signals. The timing controller 500 can supply the digital video data DATA and the data control signal DCS to the display driver 200 to control an operation timing of the display driver 200. The display driver 200 can convert the digital video data DATA into the analog data voltages and supply the analog data voltages to the data lines DL. The timing controller 500 can generate the scan control signal SCS based on the timing signals. The timing controller 500 can supply the scan control signal SCS to the scan driver 220 to control an operation timing of the scan driver 220. The timing controller 500 can vary a driving frequency of the display panel 100 based on an input frequency received from the host system or the set module.

The power supply unit 600 can supply a power supply voltage to the power supply lines VL. The power supply voltage can include the driving voltage VDD, the low potential voltage VSS, the initialization voltage Vint, the reference voltage VREF, and the bias voltage Vbias, but is not limited thereto. The power supply unit 600 can generate the driving voltage VDD and supply the driving voltage VDD to a driving voltage line, generate the initialization voltage Vint and supply the initialization voltage Vint to an initialization voltage line, generate the bias voltage Vbias and supply the bias voltage Vbias to a bias voltage line, generate the reference voltage VREF and supply the reference voltage VREF to a reference voltage line, and generate the low potential voltage VSS and supply the low potential voltage VSS to a low potential line.

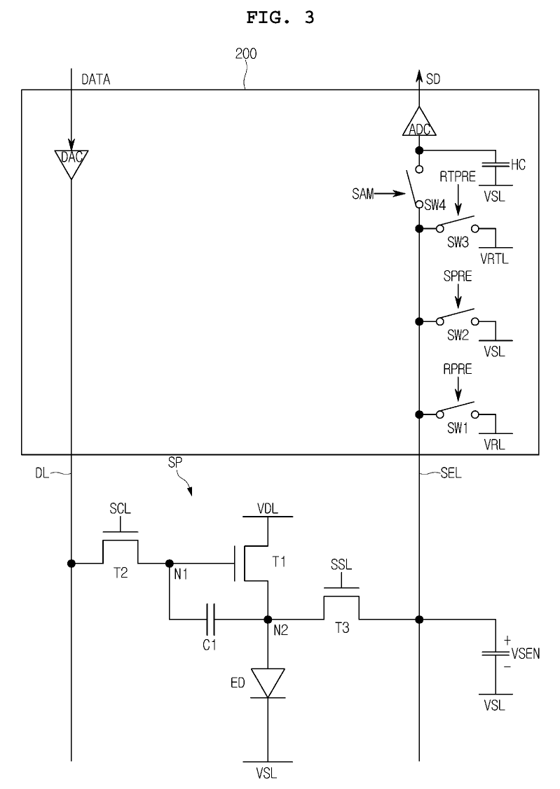

FIG. 3 is a circuit diagram illustrating the display driver and the pixel of the display device according to an embodiment of the present disclosure.

Referring to FIG. 3, each of the plurality of pixels SP can be connected to a first scan line SCL, a second scan line SSL, the data line DL, a sensing line SEL, a driving voltage line VDL, and a low potential line VSL.

The pixel SP can include first to third transistors T1, T2 and T3, a first capacitor C1, and a light emitting element ED.

The first transistor T1 can include a gate electrode, a drain electrode, and a source electrode. The gate electrode of the first transistor T1 can be connected to a first node N1, the drain electrode thereof can be connected to the driving voltage line VDL, and the source electrode thereof can be connected to a second node N2. The drain electrode of the first transistor T1 can receive a driving voltage VDD from the driving voltage line VDL. The first transistor T1 can be a driving transistor configured to adjust a current flowing from the driving voltage line VDL to the light emitting element ED according to a voltage gap between the gate electrode and the source electrode. The first transistor T1 can operate as a source follower. The first transistor T1 can control a current (or a driving current) between the drain and the source based on the data voltage applied to the gate electrode.

The light emitting element ED can emit light by receiving the driving current. An emission amount or luminance of the light emitting element ED can be proportional to a magnitude of the driving current. The light emitting element ED can include at least one among an organic light emitting diode which includes an organic light emitting layer, a quantum dot light emitting diode which includes a quantum dot light emitting layer, an inorganic light emitting diode which includes an inorganic light emitting layer, and a micro light emitting diode (micro-LED), but is not limited thereto.

A first electrode of the light emitting element ED can be connected to the second node N2. Through the second node N2, the first electrode of the light emitting element ED can be connected to the source electrode of the first transistor T1, a drain electrode of the third transistor T3, and a second capacitor electrode of the first capacitor C1. A second electrode of the light emitting element ED can be connected to the low potential line VSL. The second electrode of the light emitting element ED can receive the low potential voltage VSS from the low potential line VSL.

The second transistor T2 can be turned on by a first scan signal of the first scan line SCL, and can electrically connect the data line DL and the first node N1 which is the gate electrode of the first transistor T1 to each other. As the second transistor T2 is turned on the first scan signal, the second transistor T2 can supply a data voltage to the first node N1. A gate electrode of the second transistor T2 can be connected to the first scan line SCL, a drain electrode thereof can be connected to the data line DL, and a source electrode thereof can be connected to the first node N1. The source electrode of the second transistor T2 can be electrically connected to the gate electrode of the first transistor T1 and a first capacitor electrode of the first capacitor C1 through the first node N1.

The third transistor T3 can be turned on by a second scan signal of the second scan line SSL, and can electrically connect the sensing line SEL and the second node N2 which is the source electrode of the first transistor T1 to each other. As the third transistor T3 is turned on based on the second scan signal, it can supply one among the reference voltage VREF, the low potential voltage VSS, and the variable initialization voltage VRTA to the second node N2. A gate electrode of the third transistor T3 can be connected to the second scan line SSL, a drain electrode thereof can be connected to the second node N2, and a source electrode thereof can be connected to the sensing line SEL. Through the second node N2, the drain electrode of the third transistor T3 can be electrically connected to the source electrode of the first transistor T1, the second capacitor electrode of the first capacitor C1, and the first electrode of the light emitting element ED.

For example, the drain electrode and the source electrode of each of the first to third transistors T1, T2 and T3 may not be limited to what is described above, and can be formed reversely to each other. Each of the first to third transistors T1, T2 and T3 can be a MOSFET (metal oxide semiconductor field effect transistor) in an n-type, but is not limited thereto.

The display driver 200 can include first to fourth switching elements SW1, SW2, SW3 and SW4, a holding capacitor HC, an analog-to-digital converter ADC, and a digital-to-analog converter DAC.

The first switching element SW1 can electrically connect the sensing line SEL to a reference voltage line VRL based on the first switching signal RPRE. When the first switching element SW1 is turned on, the reference voltage line VRL can supply the reference voltage VREF to the sensing line SEL.

The second switching element SW2 can electrically connect the sensing line SEL to the low potential line VSL based on a second switching signal SPRE. For example, the second switching element SW2 can be ground-connected. When the second switching element SW2 is turned on, the low potential line VSL can supply the low potential voltage VSS to the sensing line SEL.

The third switching element SW3 can electrically connect the sensing line SEL to a variable initialization line VRTL based on a third switching signal RTPRE. When the third switching element SW3 is turned on, the variable initialization line VRTL can supply the variable initialization voltage VRTA to the sensing line SEL.

The variable initialization voltage VRTA can have each different voltage level at the real time sensing (RT) interval and the off-state real time sensing (OFF-RS) interval. For example, the variable initialization voltage VRTA can have a first voltage level at the second RT interval, and a second voltage level higher than the first voltage level at the OFF-RS interval. The variable initialization voltage VRTA can be an initialization voltage for sensing of the pixel SP at the second RT interval. The variable initialization voltage VRTA can be used for correction of an offset voltage of the display driver 200 at the OFF-RS interval. At the OFF-RS interval, the display driver 200 can supply the variable initialization voltage VRTA to the dummy channel, and sense the pixel SP using the ADC, thereby correcting the offset voltage.

In the display device 10, the sensing time and the data voltage at the RT interval and the OFF-RS interval are different from each other, and therefore, the reference voltages of the ADC can be different from each other. Therefore, as the display device 10 uses the variable initialization voltage VRTA in each different voltage level at each of the RT interval and the OFF-RS interval, the display device 10 can perform sensing easily at the RT interval which is relatively small and has a high frequency and a high resolution, and can determine an appropriate compensation value by securing a constant sensing value. The display device 10 can perform sensing easily at the RT interval even in a case where the data voltage Vdata is reduced by decreasing the power supply voltage VDD so as to reduce power consumption.

The fourth switching element SW4 can electrically connect the sensing line SEL to the ADC based on a fourth switching signal SAM. When the fourth switching element SW4 is turned on, the sensing line SEL can supply the sensing signal to the ADC, and the ADC can convert the sensing signal into digital data to generate the sensing data SD. The ADC can supply the sensing data SD to a compensation circuit of the timing controller 500.

The fourth switching element SW4 can electrically connect the sensing line SEL to the hold capacitor HC based on the fourth switching signal SAM. When the fourth switching element SW4 is turned on, the hold capacitor HC can maintain a potential gap between the sensing line SEL and the low potential line VSL. Therefore, when the fourth switching element SW4 is turned on, the hold capacitor HC can hold a voltage applied to the sensing line SEL.

The DAC can receive digital video data DATA, in which the sensing data SD is reflected, from the compensation circuit of the timing controller 500. The DAC can convert digital video data DATA into analog data to generate a data voltage Vdata. The DAC can supply the data voltage Vdata to the data line DL.

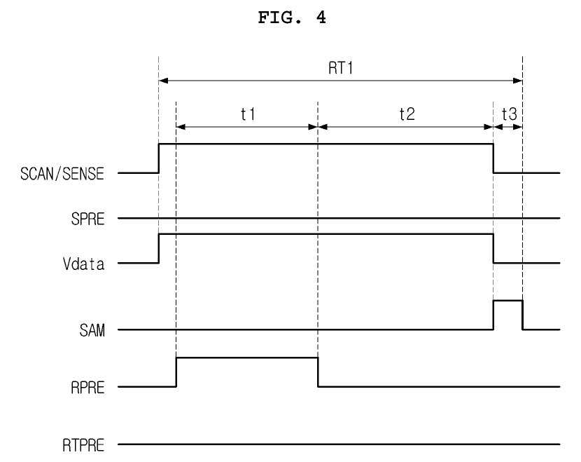

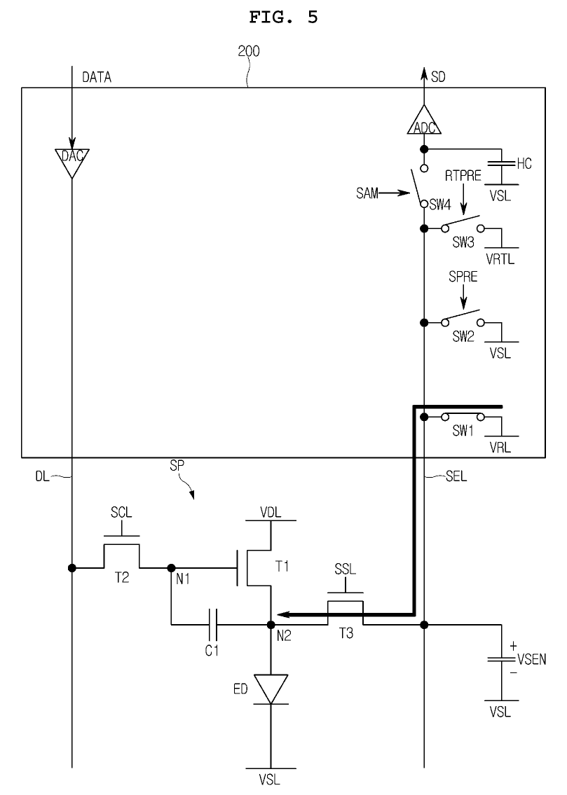

FIG. 4 is a timing diagram illustrating the signal and the voltage at the first RT interval in the display device according to an embodiment of the present disclosure, and FIG. 5 is a circuit diagram illustrating an operation of the display driver and the pixel according to the timing diagram in FIG. 4.

Referring to FIGS. 4 and 5, the plurality of pixels SP can emit light in an active period. The pixels SP disposed in some row among the plurality of pixels SP can be sensed by the display driver 200 at the RT interval, and the pixels SP disposed in another row among the plurality of pixels SP can maintain, in a blank period, luminance owned in a previous active period. Therefore, the RT interval can be applied to the pixels SP of some row in the blank period. The display driver 200 can sense characteristics such as electron mobility or a threshold voltage of the first transistor T1 of the pixels SP at the RT interval.

The RT interval can include a first RT interval RT1. The first RT interval RT1 can include first to third period t1, t2, and t3 which proceed sequentially.

The pixel SP can receive a first scan signal SCAN in a high level (or a gate-on voltage) and a second scan signal SENSE in a high level in the first and second periods t1 and t2. The second transistor T2 can be turned on based on the first scan signal SCAN, and the third transistor T3 can be turned on based on the second scan signal SENSE.

The data line DL can supply the data voltage Vdata which corresponds to data for sensing to the pixel SP in the first and second periods t1 and t2. The second transistor T2 can be turned on in the first and second periods t1 and t2, and supply the data voltage Vdata to the first node N1 which is the gate electrode of the first transistor T1. The first switching element SW1 can receive the first switching signal RPRE in a high level in the first period t1. The first switching element SW1 can be turned on in the first period t1, and can electrically connect the reference voltage line VRL and the sensing line SEL to each other. The reference voltage line VRL can supply the reference voltage VREF to the sensing line SEL in the first period t1. The third transistor T3 can be turned on in the first and second periods t1 and t2, and can supply the reference voltage VREF to the second node N2 which is the source electrode of the first transistor T1.

A gate-source voltage (Vgs=Vdata–VREF) of the first transistor T1 can be greater than the threshold voltage Vth of the first transistor T1 in the first and second periods t1 and t2 (Vgs>Vth), and the first transistor T1 can be turned on until the gate-source voltage Vgs of the first transistor T1 reaches the threshold voltage Vth of the first transistor T1. Therefore, a voltage of the second node N2, which is the source electrode of the first transistor T1, can increase up to “Vdata-Vth”, and the threshold voltage Vth of the first transistor T1 can be sampled in the second node N2.

The fourth switching element SW4 can receive the fourth switching signal SAM in a high level in the third period t3. The fourth switching element SW4 can electrically connect the ADC to the sensing line SEL in the third period t3. The sensing line SEL can have a sensing voltage VSEN. The sensing voltage VSEN can be sensed through the sensing line SEL and the ADC as a sensing signal.

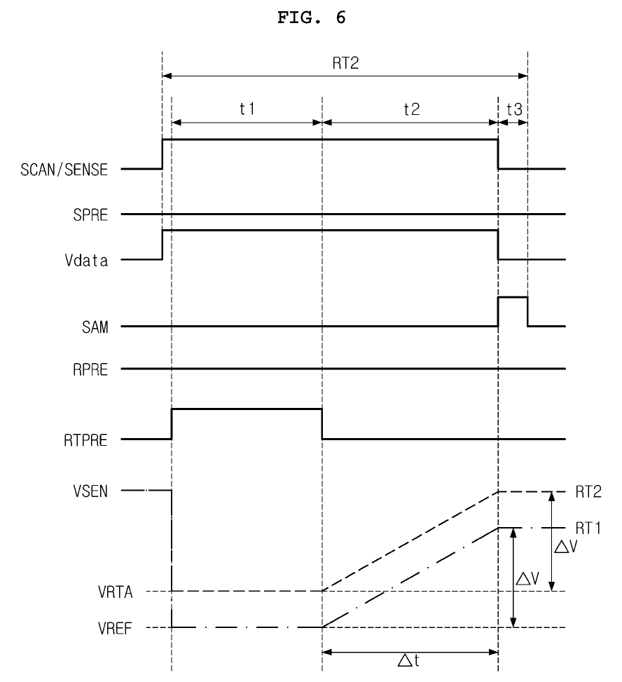

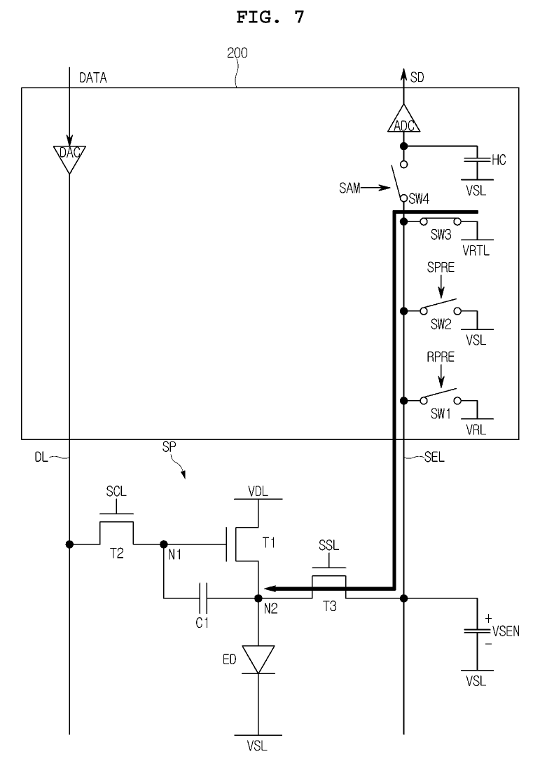

FIG. 6 is a timing diagram illustrating the signal and the voltage at the second RT interval in the display device according to an embodiment of the present disclosure, and FIG. 7 is a circuit diagram illustrating an operation of the display driver and the pixel according to the timing diagram in FIG. 6.

Referring to FIGS. 6 and 7, the RT interval can further include a second RT interval RT2. The second RT interval RT2 can include first to third periods t1, t2 and t3 which proceed sequentially.

The pixel SP can receive the first scan signal SCAN in a high level (or a gate-on voltage) and a second scan signal SENSE in a high level in the first and second periods t1 and t2. The second transistor T2 can be turned on based on the first scan signal SCAN, and the third transistor T3 can be turned on based on the second scan signal SENSE.

The data line DL can supply the data voltage Vdata which corresponds to data for sensing to the pixel SP in the first and second periods t1 and t2. The second transistor T2 can be turned on in the first and second periods t1 and t2, and supply the data voltage Vdata to the first node N1 which is the gate electrode of the first transistor T1. The third switching element SW3 can receive the third switching signal RTPRE in a high level in the first period t1. The third switching element SW3 can be turned on in the first period t1, and can electrically connect the variable initialization line VRTL and the sensing line SEL to each other. The variable initialization line VRTL can supply the variable initialization voltage VRTA to the sensing line SEL in the first period t1. The third transistor T3 can be turned on in the first and second periods t1 and t2, and can supply the variable initialization voltage VRTA to the second node N2 which is the source electrode of the first transistor T1.

The gate-source voltage (Vgs=Vdata–VRTA) of the first transistor T1 can be greater than the threshold voltage Vth of the first transistor T1 in the first and second periods t1 and t2 (Vgs>Vth), and the first transistor T1 can be turned on until the gate-source voltage Vgs of the first transistor T1 reaches the threshold voltage Vth of the first transistor T1. Therefore, the voltage of the second node N2, which is the source electrode of the first transistor T1, can increase up to “Vdata-Vth”, and the threshold voltage Vth of the first transistor T1 can be sampled in the second node N2.

The fourth switching element SW4 can receive the fourth switching signal SAM in a high level in the third period t3. The fourth switching element SW4 can electrically connect the ADC to the sensing line SEL in the third period t3. The sensing line SEL can have a sensing voltage VSEN. The sensing voltage VSEN can be sensed through the sensing line SEL and the ADC as a sensing signal.

At the first and second RT intervals RT1 and RT2, a voltage level of the variable initialization voltage VRTA can be greater than a voltage level of the reference voltage VREF. The sensing voltage VSEN can have the reference voltage VREF in the first period t1 of the first RT interval RT1, and can gradually increase in the second period t2 thereof. The sensing voltage VSEN can have the variable initialization voltage VRTA in the first period t1 of the second RT interval RT2, and can gradually increase in the second period t2 thereof. In the second period t2 of each of the first and second RT intervals RT1 and RT2, a change amount (dV/dt) of the sensing voltage VSEN can be substantially the same, but is not limited thereto. The sensing voltage VSEN in the third period t3 of the second RT interval RT2 can be greater than the sensing voltage VSEN in the third period of the first RT interval RT1. In the display device 10, a charging time of the sensing voltage VSEN can decrease and it can be difficult to secure a sufficient sensing voltage VSEN, because the RT interval decreases as the frequency becomes higher. Therefore, the display device 10 can secure the sensing voltage VSEN having a sufficient value in a relatively short period of time, by supplying the variable initialization voltage VRTA at the second RT interval RT2. Here, the sufficient value of the sensing voltage VSEN can be a value which is set to accurately determine a data compensation value. The display device 10 can improve sensing sensitivity and determine an appropriate compensation value by securing the sensing voltage VSEN having a sufficient value. The display device 10 can perform sensing easily at the RT interval which is relatively small and has a high frequency and a high resolution, and can determine an appropriate compensation value by securing a constant sensing value. The display device 10 can perform sensing at the RT interval even in a case where a data voltage Vdata is reduced by decreasing a power supply voltage so as to reduce power consumption.

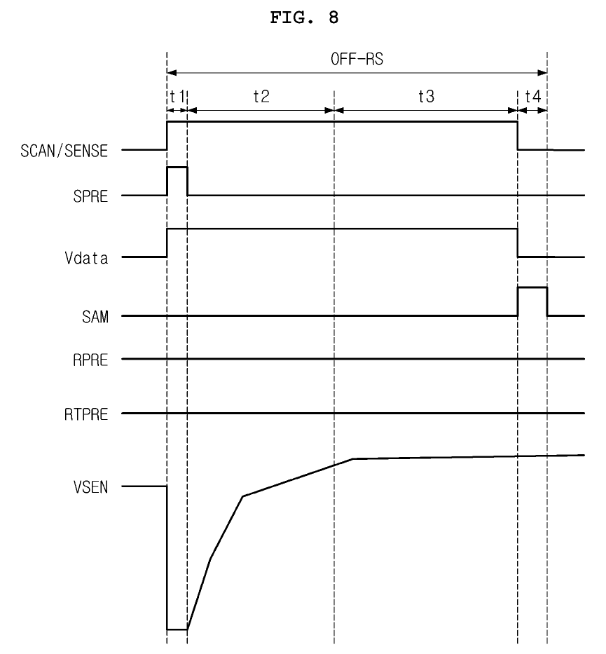

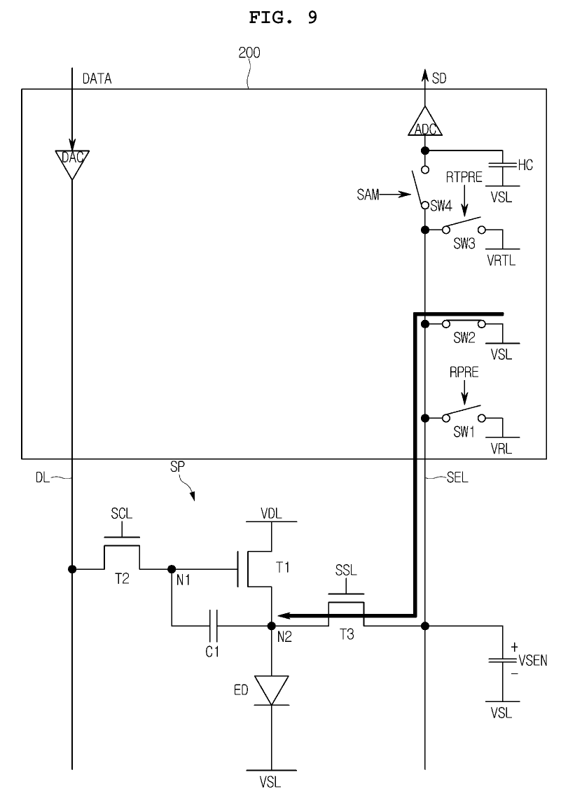

FIG. 8 is a timing diagram illustrating a signal and a voltage at an OFF-RS interval in the display device according to an embodiment of the present disclosure, and FIG. 9 is a circuit diagram illustrating an operation of the display driver and the pixel according to the timing diagram in FIG. 8.

Referring to FIGS. 8 and 9, the OFF-RS interval OFF-RS can include first to fourth periods t1, t2, t3 and t4 which proceed sequentially.

The pixel SP can receive a first scan signal SCAN in a high level (or a gate-on voltage) and can receive a second scan signal SENSE in a high level in the first to third periods t1, t2 and t3. The second transistor T2 can be turned on based on the first scan signal SCAN, and the third transistor T3 can be turned on based on the second scan signal SENSE.

The data line DL can supply the data voltage Vdata which corresponds to data for sensing to the pixel SP in the first to third periods t1, t2 and t3. The second transistor T2 can be turned on in the first to third periods t1, t2 and t3, and supply the data voltage Vdata to the first node N1 which is the gate electrode of the first transistor T1. The second switching element SW2 can receive the second switching signal SPRE in a high level in the first period t1. The second switching element SW2 can be turned on in the first period t1, and can electrically connect the low potential line VSL and the sensing line SEL to each other. The low potential line VSL can supply the low potential voltage VSS to the sensing line SEL in the first period t1. The third transistor T3 can be turned on in the first to third periods t1, t2 and t3, and can supply the low potential voltage VSS to the second node N2 which is the source electrode of the first transistor T1.

A gate-source voltage (Vgs=Vdata–VSS) of the first transistor T1 can be greater than the threshold voltage Vth of the first transistor T1 in the first to third periods t1, t2 and t3 (Vgs>Vth), and the first transistor T1 can be turned on until the gate-source voltage Vgs of the first transistor T1 reaches the threshold voltage Vth of the first transistor T1. Therefore, a voltage of the second node N2, which is the source electrode of the first transistor T1, can increase up to “Vdata-Vth”, and the threshold voltage Vth of the first transistor T1 can be sampled in the second node N2.

The fourth switching element SW4 can receive the fourth switching signal SAM in a high level in the fourth period t4. The fourth switching element SW4 can electrically connect the ADC to the sensing line SEL in the fourth period t4. The sensing line SEL can have a sensing voltage VSEN. The sensing voltage VSEN can be sensed through the sensing line SEL and the ADC as a sensing signal. The sensing voltage VSEN can have the low potential voltage VSS in the first period t1, and can gradually increase in the second period t2. The sensing voltage VSEN can have the greatest value in the third and fourth periods t3 and t4.

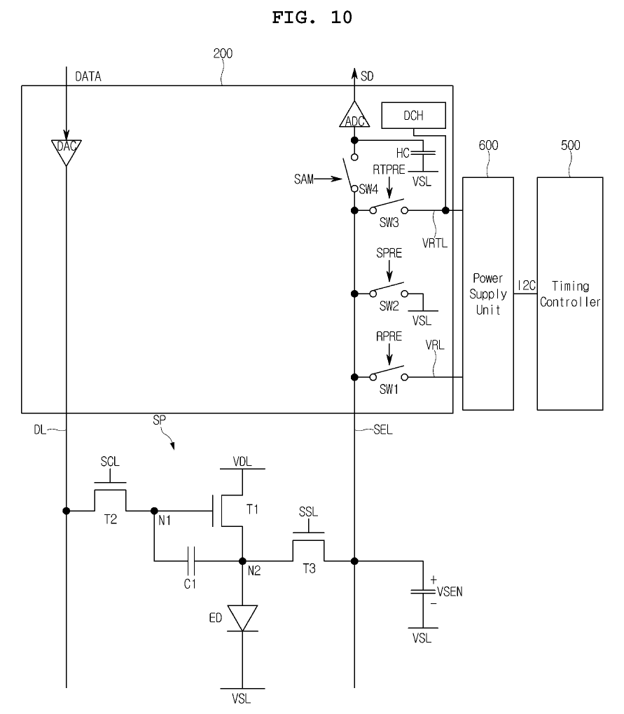

FIG. 10 is a circuit diagram illustrating a connection relationship among the display driver, the power supply unit, and the timing controller in the display device according to an embodiment of the present disclosure. Hereinafter, the same configuration as the configuration described above will be briefly described or omitted.

Referring to FIG. 10, the timing controller 500 can control the power supply unit 600 through an I2C protocol. The timing controller 500 can determine an operation of the power supply unit 600 by determining the second RT interval RT2 or the OFF-RS interval OFF-RS.

The power supply unit 600 can supply the reference voltage VREF and the variable initialization voltage VRTA to the display driver 200. The power supply unit 600 can supply the reference voltage VREF to the first switching element SW1 through the reference voltage line VRL.

The power supply unit 600 can supply the variable initialization voltage VRTA to the third switching element SW3 and the dummy channel DCH through the variable initialization line VRTL. The variable initialization voltage VRTA can have each different voltage level at the RT interval and the OFF-RS interval. For example, the variable initialization voltage VRTA can have a first voltage level at the second RT interval, and a second voltage level higher than the first voltage level at the OFF-RS interval OFF-RS. The variable initialization voltage VRTA can be an initialization voltage for sensing of the pixel SP at the second RT interval. The variable initialization voltage VRTA can be used for correction of an offset voltage of the display driver 200 at the OFF-RS interval OFF-RS. At the OFF-RS interval OFF-RS, the display driver 200 can supply the variable initialization voltage VRTA to the dummy channel DCH, and sense the pixel SP using the ADC, thereby correcting the offset voltage.

The dummy channel DCH can be provided separately so as to correct the offset voltage of the display device 10. The dummy channel DCH can be electrically connected to the ADC of the display driver 200 without passing thorough the pixel SP. For example, the variable initialization voltage VRTA having the second voltage level can be transferred to the ADC through the dummy channel DCH at the OFF-RS interval OFF-RS, and the ADC can convert the second voltage level into a digital value. Here, the second voltage level of the variable initialization voltage VRTA can be a preset value so that comparison of digital conversion values of each of the plurality of display drivers 200 can be made easy. The timing controller 500 can compare the digital conversion values of the variable initialization voltage VRTA with respect to each of the plurality of display drivers 200, and can adjust a gain of the ADC of each of the display drivers 200 so that the digital conversion values of the display drivers 200 coincide with one another. Therefore, the display drivers 200 can convert the variable initialization voltage VRTA into a constant digital value through the offset voltage correction.

As a result, the display device 10 can supply the variable initialization voltage VRTA in the first voltage level at the second RT interval RT2, and secure the sensing voltage VSEN of a sufficient value for a relatively short period of time, and can supply the variable initialization voltage VRTA in the second voltage level at the OFF-RS interval OFF-RS, thereby correcting the offset voltage of the plurality of display driver 200.

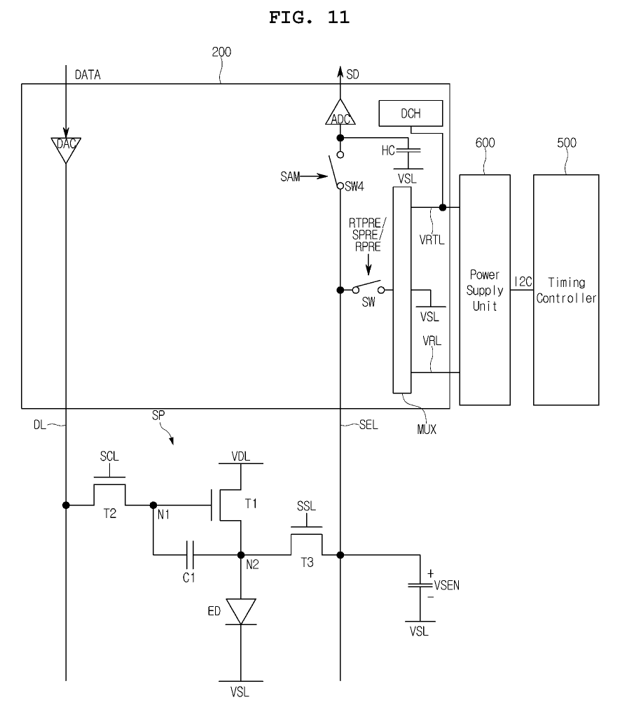

FIG. 11 is a circuit diagram illustrating a connection relationship among the display driver, the power supply unit, and the timing controller in the display device according to another embodiment of the present disclosure. The display driver 200 in FIG. 11 further includes a mux or multiplexer MUX in the display driver 200, and an operation of the display driver 200 in FIG. 11 can be substantially the same as an operation of the display driver 200 in FIG. 10. For example, the display driver 200 in FIG. 11 can receive the voltage and the signal illustrated in FIGS. 4, 6, and 8.

Referring to FIG. 11, the timing controller 500 can control the power supply unit 600 through the I2C protocol. The timing controller 500 can determine an operation of the power supply unit 600 by determining the second RT interval RT2 or the OFF-RS interval OFF-RS.

The power supply unit 600 can supply the reference voltage VREF and the variable initialization voltage VRTA to the display driver 200. The power supply unit 600 can supply the reference voltage VREF to the mux MUX through the reference voltage line VRL. The power supply unit 600 can supply the variable initialization voltage VRTA to the mux MUX and the dummy channel DCH through the variable initialization line VRTL.

The mux MUX can be electrically connected to the sensing line SEL through the switching element SW. The mux MUX can supply one among the reference voltage VREF, the low potential voltage VSS, and the variable initialization voltage VRTA to the switching element SW.

The switching element SW can be turned on by receiving one among the first to third switching signals RPRE, SPRE and RTPRE. The switching element SW can be turned on based on the first switching signal RPRE and supply the reference voltage VREF to the sensing line SEL. The switching element SW can be turned on based on the third switching signal RTPRE and supply the variable initialization voltage VRTA to the sensing line SEL.

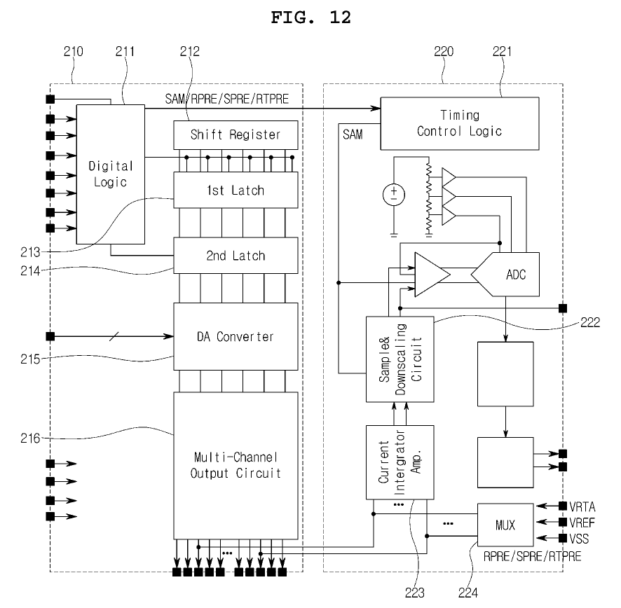

FIG. 12 is a block diagram illustrating a driving module and a sensing module of the display driver in the display device according to an embodiment of the present disclosure.

Referring to FIG. 12, the display driver 200 can include a driving module 210 and a sensing module 220. The driving module 210 can include a digital logic 211, a shift register 212, a first latch 213, a second latch 214, a digital-to-analog converter 215, and a multi-channel output circuit 216.

The digital logic 211 can compute an input signal, and supply it to the shift register 212, the first latch 213, and the second latch 214.

The first latch 213 can receive a signal of the digital logic 211 and the shift register 212, and transmit an output value to the second latch 214.

The second latch 214 can receive a signal of the digital logic 211 and the first latch 213, and transmit an output value to the DAC 215.

The DAC 215 can receive an input signal and a signal of the second latch 214, and transmit an output value to the multi-channel output circuit 216.

The multi-channel output circuit 216 can receive an input signal and a signal of the DAC 215, and supply a data voltage in correspondence with the digital video data DATA.

The sensing module 220 can include a timing control logic 221, a sample downscaling circuit 222, a current integration circuit 223, and a mux 224.

The timing control logic 221 can receive first to fourth switching signals RPRE, SPRE, RTPRE, and SAM, and output an appropriate signal according to a timing. The timing control logic 221 can supply the fourth switching signal SAM to the sample downscaling circuit 222.

The current integration circuit 223 can receive the sensing voltage VSEN stored in the sensing line SEL as a sensing signal. The current integration circuit 223 can supply the sensing signal to the sample downscaling circuit 222. The sensing module 220 can convert the sensing signal which is downscaled in the sample downscaling circuit 222 into digital data, and generate sensing data SD.

The mux 224 can supply one among the reference voltage VREF, the low potential voltage VSS, and the variable initialization voltage VRTA to the sensing line SEL. The mux 224 can supply the reference voltage VREF to the sensing line SEL based on the first switching signal RPRE. The mux 224 can supply the low potential voltage VSS to the sensing line SEL based on the second switching signal SPRE. The mux 224 can supply the variable initialization voltage VRTA to the sensing line SEL based on the third switching signal RTPRE.

The display device 10 according to various embodiments of the present disclosure can be described as below.

One embodiment of the present disclosure can provide a display device, including: a display panel having a light emitting element configured to emit light and a pixel connected to a data line and a sensing line; and a display driver configured to receive a sensing signal from the sensing line at a first RT interval, a second RT interval, and an OFF-RS interval, and the display driver can include: a first switching element configured to be turned on based on a first switching signal at the first RT interval and electrically connect a reference voltage line to the sensing line; a second switching element configured to be turned on based on second switching signal at the OFF-RS interval and electrically connect a low potential line to the sensing line; and a third switching element configured to be turned on based on a third switching signal at the second RT interval and electrically connect a variable initialization line to the sensing line.

In the display device according to various embodiments of the present disclosure, the display driver can further include: an analog-to-digital converter configured to output sensing data; and a fourth switching element configured to be turned on based on a fourth switching signal and electrically connect the analog-to-digital converter to the sensing line.

In the display device according to various embodiments of the present disclosure, the pixel can include: a first transistor disposed between a driving voltage line and the light emitting element and configured to supply a driving current to the light emitting element; a second transistor configured to electrically connect the data line and a gate electrode of the first transistor based on a first scan signal; and a third transistor configured to electrically connect the sensing line and a source electrode of the first transistor based on a second scan signal.

In the display device according to various embodiments of the present disclosure, the first RT interval can include first to third periods sequentially proceeding, and each of the first and second transistors can be turned on in the first period and the second period of the first RT interval, the first switching element can be turned on in the first period of the first RT interval, and the fourth switching element can be turned on in the third period of the first RT interval.

In the display device according to various embodiments of the present disclosure, a source electrode of the first transistor can receive a reference voltage supplied from the reference voltage line in the first period of the first RT interval.

In the display device according to various embodiments of the present disclosure, the second RT interval can include first to third periods sequentially proceeding, and each of the first and second transistors can be turned on in the first period and the second period of the second RT interval, the third switching element can be turned on in the first period of the second RT interval, and the fourth switching element can be turned on in the third period of the second RT interval.

In the display device according to various embodiments of the present disclosure, a source electrode of the first transistor can receive a variable initialization voltage supplied from the variable initialization line in a first period of the second RT interval.

In the display device according to various embodiments of the present disclosure, a voltage level of the variable initialization voltage can be greater than a voltage level of a reference voltage supplied from the reference voltage line.

In the display device according to various embodiments of the present disclosure, the OFF-RS interval can include first to fourth periods sequentially proceeding, and each of the first and second transistors can be turned on in the first period to the third period of the OFF-RS interval, the second switching element can be turned on in the first period of the OFF-RS interval, and the fourth switching element can be turned on in the fourth period of the OFF-RS interval.

In the display device according to various embodiments of the present disclosure, the display driver can further include a dummy channel, and the dummy channel can receive a variable initialization voltage supplied from the variable initialization line at the OFF-RS interval, and the variable initialization voltage can have a first voltage level at the second RT interval, and have a second voltage level higher than the first voltage level at the OFF-RS interval.

In the display device according to various embodiments of the present disclosure, the display device can further include: a power supply unit configured to supply a reference voltage to the reference voltage line and supply a variable initialization voltage to the variable initialization line; and a timing controller configured to determine an operation of the power supply unit by determining the second RT interval, or the OFF-RS interval.

Another embodiment of the present disclosure can provide a display device, including: a display panel having a light emitting element configured to emit light and a pixel connected to a data line and a sensing line; and a display driver configured to receive a sensing signal from the sensing line at a first RT interval, a second RT interval, and an OFF-RS interval, and the display driver can include: a mux configured to receive a reference voltage from a reference voltage line, receive a low potential voltage from a low potential line, and receive a variable initialization voltage from a variable initialization line; and a switching element configured to be turned on based on one among first to third switching signals and supply one among the reference voltage, the low potential voltage, and the variable initialization voltage to the sensing line.

In the display device according to various embodiments of the present disclosure, the display driver can further include: an analog-to-digital converter configured to output sensing data; and a fourth switching element configured to be turned on based on a fourth switching signal and electrically connect the analog-to-digital converter to the sensing line.

In the display device according to various embodiments of the present disclosure, the pixel can include: a first transistor disposed between a driving voltage line and the light emitting element and configured to supply a driving current to the light emitting element; a second transistor configured to electrically connect the data line and a gate electrode of the first transistor based on a first scan signal; and a third transistor configured to electrically connect the sensing line and a source electrode of the first transistor based on a second scan signal.

In the display device according to various embodiments of the present disclosure, the first RT interval can include first to third periods sequentially proceeding, and each of the first and second transistors can be turned on in the first period and the second period of the first RT interval, the switching element can be turned on in the first period of the first RT interval based on the first switching signal and supply the reference voltage to the sensing line, and the fourth switching element can be turned on in the third period of the first RT interval.

In the display device according to various embodiments of the present disclosure, the second RT interval comprises first to third periods sequentially proceeding, and each of the first and second transistors can be turned on in the first period and the second period of the second RT interval, the switching element can be turned on in the first period of the second RT interval based on the third switching element and supply the variable initialization voltage to the sensing line, and the fourth switching element can be turned on in the third period of the second RT interval.

In the display device according to various embodiments of the present disclosure, a voltage level of the variable initialization voltage can be greater than a voltage level of the reference voltage.

In the display device according to various embodiments of the present disclosure, the OFF-RS interval can include first to fourth periods sequentially proceeding, and each of the first and second transistors can be turned on in the first period to the third period of the OFF-RS interval, the switching element can be turned on in the first period of the OFF-RS interval based on the second switching signal and supply the low potential voltage to the sensing line, and the fourth switching element can be turned on in the fourth period of the OFF-RS interval.

In the display device according to various embodiments of the present disclosure, the display driver can further include a dummy channel, and the dummy channel can receive a variable initialization voltage supplied from the variable initialization line at the OFF-RS interval, and the variable initialization voltage can have a first voltage level at the second RT interval, and have a second voltage level higher than the first voltage level at the OFF-RS interval.

In the display device according to various embodiments of the present disclosure, the display device can further include: a power supply unit configured to supply a reference voltage to the reference voltage line and supply a variable initialization voltage to the variable initialization line; and a timing controller configured to determine an operation of the power supply unit by determining the second RT interval, or the OFF-RS interval.

The embodiments of the present disclosure have been described with reference to accompanying drawings. Those of ordinary skill in the art will recognize that the present disclosure can be embodied in other specific forms without departing from its spirit or essential characteristics. The described embodiments of the present disclosure are to be considered in all respects only as illustrative and not restrictive. The scope of the present disclosure is therefore indicated by the appended claims rather than by the foregoing description. All changes which come within meaning and range of equivalency of the claims are to be embraced within the scope of the present disclosure.

What is claimed is:

1. A display device, comprising:
a display panel having a pixel comprising a light emitting element configured to emit light and connected to a data line and a sensing line; and
a display driver configured to receive a sensing signal from the sensing line at a first real time sensing (RT) interval, a second RT interval, and an off-state real time sensing (OFF-RS) interval,
wherein the display driver comprises:
a first switching element configured to be turned on based on a first switching signal at the first RT interval, and electrically connect a reference voltage line to the sensing line;
a second switching element configured to be turned on based on a second switching signal at the OFF-RS interval, and electrically connect a low potential line to the sensing line; and
a third switching element configured to be turned on based on a third switching signal at the second RT interval, and electrically connect a variable initialization line to the sensing line.

2. The display device of claim 1,
wherein the display driver further comprises:
an analog-to-digital converter configured to output sensing data; and
a fourth switching element configured to be turned on based on a fourth switching signal, and electrically connect the analog-to-digital converter to the sensing line.

3. The display device of claim 2,
wherein the pixel comprises:
a first transistor disposed between a driving voltage line and the light emitting element, and configured to supply a driving current to the light emitting element;
a second transistor configured to electrically connect the data line and a gate electrode of the first transistor based on a first scan signal; and
a third transistor configured to electrically connect the sensing line and a source electrode of the first transistor based on a second scan signal.

4. The display device of claim 3,
wherein the first RT interval comprises first to third periods sequentially proceeding, and
wherein each of the first and second transistors is turned on in the first period and the second period of the first RT interval, the first switching element is turned on in the first period of the first RT interval, and the fourth switching element is turned on in the third period of the first RT interval.

5. The display device of claim 4,
wherein a source electrode of the first transistor receives a reference voltage supplied from the reference voltage line in the first period of the first RT interval.

6. The display device of claim 3,
wherein the second RT interval comprises first to third period sequentially proceeding, and
wherein each of the first and second transistors is turned on in the first period and the second period of the second RT interval, the third switching element is turned on in the first period of the second RT interval, and the fourth switching element is turned on in the third period of the second RT interval.

7. The display device of claim 6,
wherein a source electrode of the first transistor receives a variable initialization voltage supplied from the variable initialization line in the first period of the second RT interval.

8. The display device of claim 7,
wherein a voltage level of the variable initialization voltage is greater than a voltage level of a reference voltage supplied from the reference voltage line.

9. The display device of claim 7,
wherein the OFF-RS interval comprises first to fourth periods sequentially proceeding, and
wherein each of the first and second transistors is turned on in the first period to the third period of the OFF-RS interval, the second switching element is turned on in the first period of the OFF-RS interval, and the fourth switching element is turned on in the fourth period of the OFF-RS interval.

10. The display device of claim 9,
wherein the display driver further comprises a dummy channel,
wherein the dummy channel receives a variable initialization voltage supplied from the variable initialization line at the OFF-RS interval, and
wherein the variable initialization voltage has a first voltage level at the second RT interval, and has a second voltage level higher than the first voltage level at the OFF-RS interval.

11. The display device of claim 1, further comprising:
a power supply unit configured to supply a reference voltage to the reference voltage line, and supply a variable initialization voltage to the variable initialization line; and
a timing controller configured to determine an operation of the power supply unit by determining the second RT interval, or the OFF-RS interval.

12. A display device, comprising:
a display panel having a pixel comprising a light emitting element configured to emit light and connected to a data line and a sensing line; and
a display driver configured to receive a sensing signal from the sensing line at a first real time sensing (RT) interval, a second RT interval, and an off-state real time sensing (OFF-RS) interval,
wherein the display driver comprises:
a multiplexer configured to receive a reference voltage from a reference voltage line, receive a low potential voltage from a low potential line, and receive a variable initialization voltage from a variable initialization line; and
a switching element configured to be turned on based on one among first to third switching signals, and supply one among the reference voltage, the low potential voltage, and the variable initialization voltage to the sensing line.

13. The display device of claim 12,
wherein the display driver further comprises:
an analog-to-digital converter configured to output sensing data; and
another switching element configured to be turned on based on a fourth switching signal, and electrically connect the analog-to-digital converter to the sensing line.

14. The display device of claim 13,
wherein the pixel comprises:
a first transistor disposed between a driving voltage line and the light emitting element, and configured to supply a driving current to the light emitting element;
a second transistor configured to electrically connect the data line and a gate electrode of the first transistor based on a first scan signal; and
a third transistor configured to electrically connect the sensing line and a source electrode of the first transistor based on a second scan signal.

15. The display device of claim 14,
wherein the first RT interval comprises first to third periods sequentially proceeding, and
wherein each of the first and second transistors is turned on in the first period and the second period of the first RT interval, the switching element is turned on in the first period of the first RT interval based on the first switching signal and supplies the reference voltage to the sensing line, and the another switching element is turned on in the third period of the first RT interval.

16. The display device of claim 14,
wherein the second RT interval comprises first to third periods sequentially proceeding, and
wherein each of the first and second transistors is turned on in the first period and the second period of the second RT interval, the switching element is turned on in the first period of the second RT interval based on the third switching signal and supplies the variable initialization voltage to the sensing line, and the another switching element is turned on in the third period of the second RT interval.

17. The display device of claim 16,
wherein a voltage level of the variable initialization voltage is greater than a voltage level of the reference voltage.

18. The display device of claim 16,
wherein the OFF-RS interval comprises first to fourth periods sequentially proceeding, and
wherein each of the first and second transistors is turned on in the first period to the third period of the OFF-RS interval, the switching element is turned on in the first period of the OFF-RS interval based on the second switching signal and supplies the low potential voltage to the sensing line, and the another switching element is turned on in the fourth period of the OFF-RS interval.

19. The display device of claim 18,
wherein the display driver further comprises a dummy channel,
wherein the dummy channel receives a variable initialization voltage supplied from the variable initialization line at the OFF-RS interval, and
wherein the variable initialization voltage has a first voltage level at the second RT interval, and has a second voltage level higher than the first voltage level at the OFF-RS interval.

20. The display device of claim 12, further comprising:
a power supply unit configured to supply a reference voltage to the reference voltage line, and supply a variable initialization voltage to the variable initialization line; and
a timing controller configured to determine an operation of the power supply unit by determining the second RT interval, or the OFF-RS interval.
